(19) United States
(12) Patent Application Publication
(10) Pub. No.: US 2004/0047373 A1
(43) Pub. Date: Mar. 11, 2004

(54) Multichannel optical add-drop multiplexer

(76) Inventors: Wen De Zhong, Singapore (SG); Rodney Stuart Tucker, Hawthorn Victoria (AU); Kai Song, Nashua, NH (US); An Vu Tran, Brunswick (AU)

Correspondence Address: LARSON & TAYLOR, PLC, 1199 NORTH FAIRFAX STREET, SUITE 900, ALEXANDRIA, VA, 22314, US

(21) Appl. No.: 10/398,243

(22) PCT Filed: Oct. 4, 2001
(86) PCT No.: PCT/AU01/01249

(30) Foreign Application Priority Data
Oct. 4, 2000 (AU) PR 0545

(51) Int. Cl. H04J 3/04

(52) U.S. Cl. 370/535

(57) ABSTRACT

The invention broadly comprises an optical add-drop multiplexer having at least two multi-port circulators (V, W) connected in parallel and interconnected by in-fibre Bragg gratings (40, 70) in a manner such that one port (V1) of one of the circulators (V) is arranged to receive (20) a multi-channel input signal (10) and another port (V8) of the same circulator (V) is arranged to output (80) a multi-channel output signal.

### FIELD OF THE INVENTION

This invention relates to a multichannel optical add-drop multiplexer employing multi-port circulators and optical fibre Bragg gratings.

### BACKGROUND OF THE INVENTION

Multichannel add-drop multiplexers are devices that can drop more than one wavelength channel from an optical network and then add to the network a number of channels, usually the same number as have been dropped. Throughout the specification, the terms wavelength channel, wavelength and channel are used synonymously.

A number of optical add-drop multiplexer designs have been proposed and demonstrated. Such designs include an arrayed waveguide grating multiplexer, a Mach-Zender interferometer employed in conjunction with fibre Bragg gratings, and an optical circulator employed in conjunction with a fibre Bragg grating. The latter design is the most practical because of the low insertion loss, low cross talk, and polarisation insensitivity.

Recently the inventors have proposed and demonstrated a single channel optical circulator and fibre Bragg grating based optical add-drop multiplexer using a single circulator with either one or two fibre Bragg gratings. It has been demonstrated that this optical add-drop multiplexer can tolerate up to 30 dB power difference for in-band channels, and 20 dB power difference for out-of-band channels. Such a design is particularly useful for local area network applications where different channels at different points may have largely different powers.

In principle, a multichannel optical add-drop multiplexer can be built simply by cascading multiple single-channel optical add-drop multiplexers. However, this approach is not desirable for two reasons. The first is that by increasing the number of circulators used and, hence, the number of ports through which light will be directed, an unacceptable increase will occur in the insertion loss. The second reason is that if only a certain number of channels are required at one location within the optical network then it is advantageous not to guide all of the different wavelengths through all the circulators. Therefore, it is desirable that the channels that are not required at a certain location be dropped and then added in a manner which avoids them having to pass through too many ports of the circulators.

The inventors have developed an alternative to the cascaded arrangement and one which avoids at least some of the above stated difficulties.

### SUMMARY OF THE INVENTION

Broadly defined, the present invention provides an optical add-drop multiplexer having at least two multi-port circulators connected in parallel and interconnected by in-fibre Bragg gratings in a manner such that one port of one of the circulators is arranged to receive a multi-channel input signal and another port of the same circulator is arranged to output a multi-channel output signal.

It will be understood that, as a circulator has at least three ports, the term “multi-port circulator” refers to a circulator with four or more ports and is used in this manner throughout this document.

The invention may be defined further as providing an optical add-drop multiplexer comprising at least two multi-port circulators, one port of a first of the circulators being arranged to receive a multi-channel input signal and another port of the first circulator being arranged to output a multi-channel output signal. At least one in-fibre Bragg grating is located between two further ports of at least the first circulator, and additional ports of the first circulator are connected by further in-fibre Bragg gratings to ports of the or at least one of the further circulator(s) in a manner to place the circulators in parallel. Also, additional in-fibre Bragg gratings are provided to interconnect ports of the circulators in a manner to permit dropping and adding of at least two channels of the multi-channel input signal from and to ports of one or other of the circulators to which no in-fibre Bragg gratings are connected.

The or each “further” circulator as above specified may be constituted by at least two cascaded circulators.

An advantage of the add-drop multiplexer of the present invention is the significant decrease in insertion losses to the channels that are not required to be dropped at a certain location within a network. These channels, after entering the first multi-port circulator, are transmitted through Bragg gratings and are delivered from another port in the first multi-port circulator. Thus, these channels are transmitted through a minimum number of ports.

A further advantage is the reduction of cross-talk between different channels and, in particular, channels which are not required for dropping or adding at a location within the network where other channels are being dropped or added.

### BRIEF DESCRIPTION OF THE DRAWINGS

A preferred embodiment of the optical add-drop multiplexer will now be described, by way of example only, with reference to the accompanying circuit diagrams in which:

FIG. 1 shows a circuit diagram employing two eight port circulators arranged in parallel to enable the dropping and adding of three channels; and

FIG. 2 shows a circuit diagram employing three eight port circulators which enables the adding and dropping of five channels.

### DETAILED DESCRIPTION OF THE INVENTION

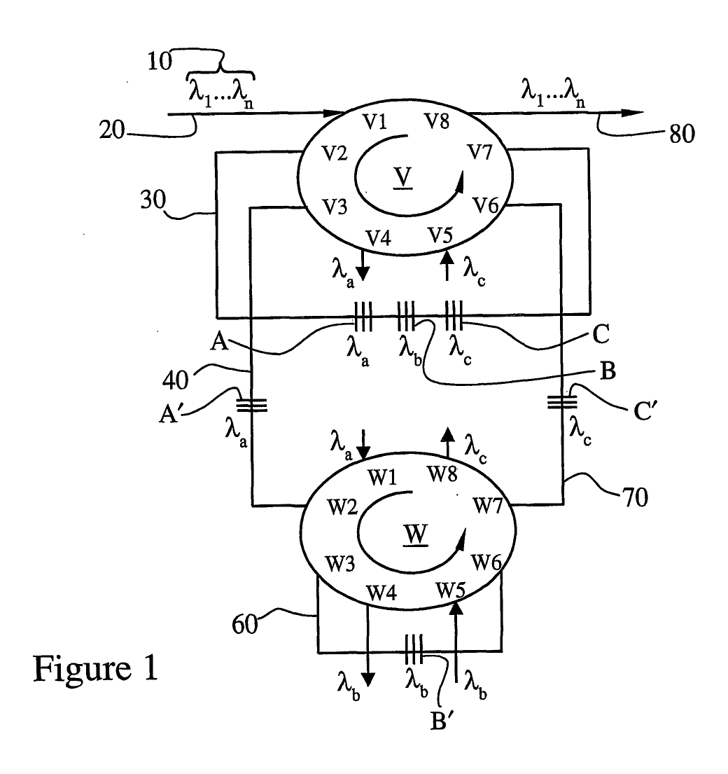

In the circuit shown in FIG. 1 light in the wavelength range λ₁ . . . λₙ 10 is launched 20 into port V1 of the multi-port circulator V. The light is then guided within the circulator to port V2. At port V2 all the light exits the circulator through an optical fibre 30. The optical fibre 30 has three Bragg gratings A, B and C along its length. These three Bragg gratings, A, B and C, reflect most of the light guided through the fibre 30 at the wavelengths λₐ, λ_{b}, and λ_{c}, while all other wavelengths, namely the wavelengths in the range λ_{T}=[(λ₁, . . . , λₙ) (λₐ, λ_{b}, λ_{c})], are transmitted through the Bragg gratings A, B and C. The transmitted wavelengths λ_{T} are guided by the fibre 30 and launched back into the circulator V at port V7 where it is further guided through the circulator V to port V8. At port V8 all light in the wavelength region λ_{T} exits from the first circulator V. Light in the range of wavelengths λ_{T} may be required for dropping and adding at a later point within the network.

At port V2 where light at the wavelengths λₐ, λ_{b}, and λ_{c} is now present as a consequence of it being reflected by the Bragg gratings A, B and C respectively. From port V2 light at the wavelengths λₐ, λ_{b}, and λ_{c}, is guided through the circulator V to port V3. At port V3 all the light exits through an optical fibre 40 containing a Bragg grating A′ which reflects at the wavelength λₐ and transmits light at all other wavelengths. Therefore, at port V3 only light at the wavelength λₐ is present while light at the wavelengths λ_{b} and λ_{c} is transmitted through the fibre 40 to port W2 of the circulator W. Light at the wavelength λₐ is then guided through the circulator V from port V3 to port V4 where it is dropped out of the network for use at a desired location.

Reference is now made to the circulator W. At port W1 of the circulator W light at the wavelength λₐ is added to the network after having been dropped at port V4 of the circulator V. The light at the wavelength λₐ is then guided through the circulator W to port W2 where light at the wavelengths λ_{b}, and λ_{c} is also present since it was transmitted through the Bragg grating A′ and guided by the fibre 40 from port V3 of the circulator V. Therefore, at port W2 of the circulator W light at the three wavelengths λₐ, λ_{b}, and λ_{c} is present. At port W2 all of the three wavelengths λₐ, λ_{b}, and λ_{c} are then guided through the circulator W to port Wee where they exit through an optical fibre 60 containing a Bragg grating B′ which reflects at the wavelength λ_{b} and transmits at all other wavelengths. Thus, only λ_{b} remains at port W3 while λₐ and λ_{c} are transmitted through the optical fibre 60 to port W6 of the circulator W. From port W3 light at the wavelength λ_{b} is guided through the circulator W to port W4 where it is dropped out of the network for use at a desired location. Light at the wavelength λ_{b} is then added at port W5 of the circulator W. From port W5 light at the wavelength λ_{b} is then guided to port W6 of the circulator W where light at the wavelengths λₐ and λ_{c} is present after having been transmitted through the Bragg grating B and guided through the optical fibre 60 from port W3 of the circulator W. Thus light at all three wavelengths λₐ, λ_{b}, and λ_{c} is present at port W6 of the circulator W. From port W6 the light is guided to port W7 where it exits through an optical fibre 70 containing a Bragg grating C′ which reflects light at the wavelength λ_{c} and transmits light at all other wavelengths. Thus, from port W7 light at the wavelength λ_{c} is guided to port W8 of the circulator W where it is dropped from the network.

Light at the wavelength λ_{c} is added to the network at port V5 of the circulator V. From port V5 the light at wavelength λ_{c} is guided to port V6 where light at all three wavelengths is present, since light at the wavelengths λₐ and λ_{b} has been transmitted through the Bragg grating C and the optical fibre 70 from port W7 of the circulator W. From port V6 of the circulator V light at all three wavelengths λₐ, λ_{b}, and λ_{c} is guided to port V7 of the circulator V. At port V7 all the light exits through the optical fibre 30 which contains three Bragg grating reflecting at the wavelengths λₐ, λ_{b}, and λ_{c} so that all the light is reflected back to port V7 from which it is then guided to port V8 of the circulator V where it exits 80 the circuit to continue through the network where it may be dropped and added at later stages as required.

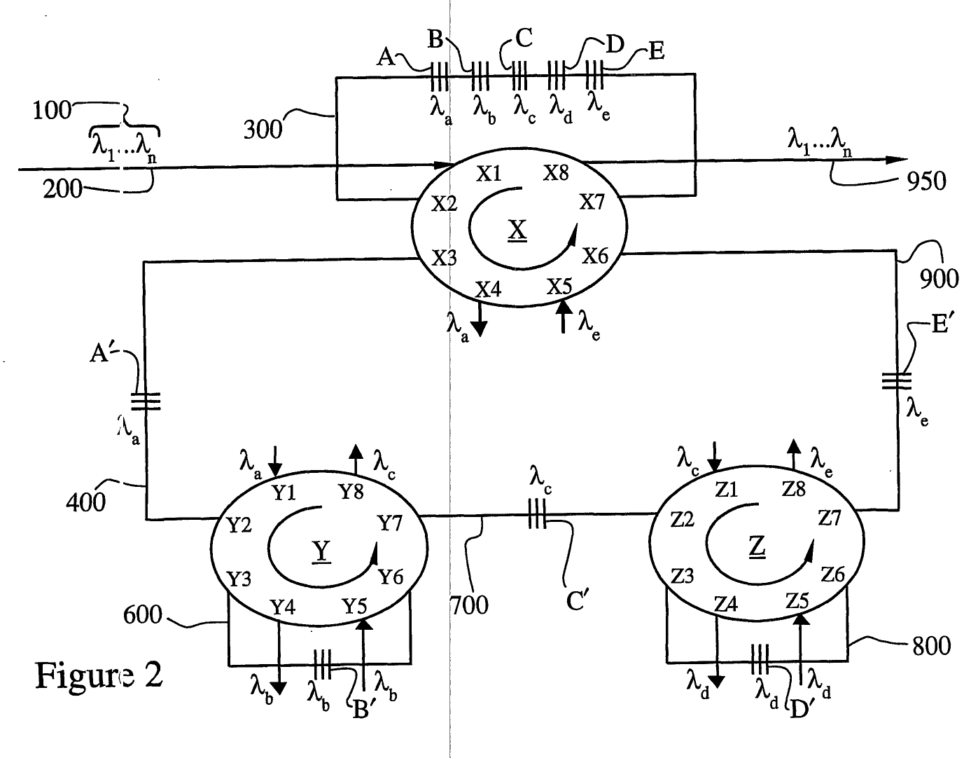

The circuit diagram shown in FIG. 2 employs an arrangement of circulators and optical fibre Bragg gratings which enables the dropping and adding of 5 different channels at the wavelengths λₐ, λ_{b}, λ_{c}, λ_{d} and λₑ.

In the circuit shown in FIG. 2 light in the wavelength range λ_{V1} . . . λₙ 100 is launched 200 into port X1 of the multi-port circulator X. The light is then guided within the circulator to port X2. At port X2 all the light exits the circulator through an optical fibre 300. The optical fibre 300 has three Bragg gratings A, B, C, D and E along its length. These three Bragg gratings, A, B, C, D and E reflect most of the light guided through the fibre 300 at the wavelengths λₐ, λ_{b}, λ_{c}, λ_{d} and λₑ while all other wavelengths, namely the wavelengths in the range λₜ=[(λ₁, . . . , λₙ)−(λₐ, λ_{b}, λ_{c}, λ_{d}, λₑ)] are transmitted through the Bragg gratings A, B, C, D and E. The transmitted wavelengths λₜ are guided by the fibre 300 and launched back into the circulator X at port X7 where it is further guided through the circulator X to port X8. At port X8 all light in the wavelength region λₜ is output from the circulator X. Light in the range of wavelengths λₜ may be required for dropping and adding at a later point within the network.

At port X2 where light at the wavelengths λₐ, λ_{b}, λ_{c}, λ_{d} and λₑ is now present since it was reflected by the Bragg gratings A, B, C, D and E respectively. From port X2 light at the wavelengths λₐ, λ_{b}, λ_{c}, λ_{d} and λₑ is guided through the circulator X to port X3. At port X3 all the light exits through an optical fibre 400 containing a Bragg grating A′ which reflects at the wavelength λₐ and transmits light at all other wavelengths. Therefore, at port X3 only light at the wavelength λₐ is present while light at the wavelengths λ_{b}, λ_{c}, λ_{d} and λₑ is transmitted through the fibre 400 to port Y2 of the circulator Y. Light at the wavelength λₐ is then guided through the circulator X from port X3 to port X4 where it is dropped out of the network for use at a desired location.

Reference is now made to circulator Y. At port Y1 of the circulator Y light at the wavelength λₐ is added to the network after having been dropped at port X4 of the circulator X. The light at the wavelength λₐ is then guided through the circulator Y to port Y2 where light at the wavelengths λ_{b}, λ_{c}, λ_{d} and λₑ is also present since it was transmitted through the Bragg grating A′ and guided by the fibre 400 from port X3 of the circulator X. Therefore, at port Y2 of the circulator Y light at the five wavelengths λₐ, λ_{b}, λ_{c}, λ_{d} and λₑ is present. At port Y2 all of the five wavelengths λₐ, λ_{b}, λ_{c}, λ_{d} and λₑ are then guided through the circulator Y to port Y3 where they exit through an optical fibre 600 containing a Bragg grating B′ which reflects at the wavelength λ_{b} and transmits at all other wavelengths. Thus, only λ_{b} remains at port Y3 while λₐ, λ_{c}, λ_{d} and λₑ are transmitted through the optical fibre 600 to port Y6 of the circulator Y. From port Y3 light at the wavelength λ_{b} is guided through the circulator Y to port Y4 where it is dropped out of the network for use at a desired location. Light at the wavelength λ_{b} is then added at port Y5 of the circulator Y. From port Y5 light at the wavelength λ_{b} is then guided to port Y6 of the circulator Y where light at the wavelengths λₐ, λ_{c}, λ_{d} and λₑ is present after having been transmitted through the Bragg grating B and guided through the optical fibre 600 from port Y3 of the circulator Y. Thus light at all five wavelengths λₐ, λ_{b}, λ_{c}, λ_{d} and λₑ is present at port Y6 of the circulator Y. From port Y6 the light is guided to port Y7 where it exits through an optical fibre 700 containing a Bragg grating C′ which reflects light at the wavelength λₑ and transmits light at all other wavelengths. Thus, from port Y7 light at the wavelength λ_{c} is guided to port Y8 of the circulator Y where it is dropped from the network.

Reference is now made to the circulator Z. At port Z1 of the circulator Z light at the wavelength λ_{c} is added to the network after having been dropped at port Y8 of the circulator Y. The light at the wavelength λ_{c} is then guided through the circulator Z to port Z2 where light at the wavelengths λₐ, λ_{b}, λ_{d} and λₑ is also present since it was transmitted through the Bragg grating C′ and guided by the fibre 700 from port Y7 of the circulator Y. Therefore, at port Z2 of the circulator Z light at the five wavelengths λₐ, λ_{b}, λ_{c}, λ_{d} and λₑ is present. At port Z2 all of the five wavelengths λₐ, λ_{b}, λ_{c}, λ_{d} and λₑ are then guided through the circulator Z to port Z3 where they exit through an optical fibre 800 containing a Bragg grating D′ which reflects at the wavelength λ_{d} and transmits at all other wavelengths. Thus, only λ_{d} remains at port Z3 while λₐ, λ_{b}, λ_{c} and λₑ are transmitted through the optical fibre 700 to port Z6 of the circulator Z. From port Z3 light at the wavelength λ_{d} is guided through the circulator Z to port Z4 where it is dropped out of the network for use at a desired location. Light at the wavelength λ_{d} is then added at port Z5 of the circulator Z. From port Z5 light at the wavelength λ_{d} is then guided to port Z6 of the circulator Z where light at the wavelengths λₐ, λ_{b}, λ_{c} and λₑ is present after having been transmitted through the Bragg grating d and guided through the optical fibre 800 from port Z3 of the circulator Z. Thus light at all five wavelengths λₐ, λ_{b}, λ_{c}, λ_{d} and λₑ is present at port Z6 of the circulator Z. From port Z6 the light is guided to port Z7 where it exits through an optical fibre 900 containing a Bragg grating E′ which reflects light at the wavelength λₑ and transmits light at all other wavelengths. Thus, from port Z7 light at the wavelength λₑ is guided to port Z8 of the circulator Z where it is dropped from the network.

Light at the wavelength λₑ is added to the network at port X5 of the circulator X. From port X5 the light at wavelength λₑ is guided to port X6 where light at all five wavelengths λₐ, λ_{b}, λ_{c}, λ_{d} and λₑ is present, since light at the wavelengths λₐ, λ_{b}, λ_{c} and λ_{d} has been transmitted through the Bragg grating E′ and the optical fibre 900 from port Z7 of the circulator Z. From port X6 of the circulator X light at all five wavelengths λₐ λ_{b}, λ_{c}, λ_{d} and λₑ is guided to port X7 of the circulator X. At port X7 all the light exits through the optical fibre 300 which contains three Bragg grating reflecting at the wavelengths λₐ, λ_{b}, λ_{c}, λ_{d} and λₑ so that all the light is reflected back to port X7 from which it is then guided to port X8 of the circulator X where it exits 950 the circuit to continue through the network where it may be dropped and added at later stages as requires.

Variations and modifications may be made in the embodiments of the invention as above described without departing from th scope of the invention as defined in the following statements of claim.

1. An optical add-drop multiplexer having at least two multi-port circulators connected in parallel and interconnected by in-fibre Bragg gratings in a manner such that one port of one of said circulators is arranged to receive a multi-channel input signal and another port of the same circulator is arranged to output a multi-channel output signal.

2. An optical add-drop multiplexer comprising:
a first multi-port circulator, one port of said first circulator being arranged to receive a multi-channel input signal and another port of said first circulator being arranged to output a multi-channel output signal;
an in-fibre Bragg grating located between two further ports of said first circulator;
a further multi-port circulator connected in parallel with said first multi-port circulator by means of further in-fibre Bragg gratings; and
additional in-fibre Bragg gratings interconnecting ports of said circulators in a manner to permit dropping and adding of at least two channels of the multi-channel input signal from and to ports of any of said circulators.

3. A multiplexer as claimed in claim 2, wherein said further circulator is one of a plurality of further circulators, each connected in parallel with said first multi-port circulator.

4. A multiplexer as claimed in claim 2, wherein said further circulator is one of a plurality of further circulators, said further circulators connected in series with each other and each connected in parallel with said first multi-port circulator.

5. A multiplexer as claimed in any one of claims 2 to 4, including one or more extra in-fibre Bragg gratings, each located between a pair of ports of a respective circulator.

6. A multiplexer as claimed in any one of claims 2 to 5, wherein said further circulator or each of said further circulators comprises at least two cascaded circulators.
